(19) United States
(12) Patent Application Publication
(10) Pub. No.: US 2026/0225361 A1
(43) Pub. Date: Aug. 6, 2026

(54) A METHOD OF MANUFACTURING A MULTI-LAYER MATERIAL

(71) Applicant: PHILIP MORRIS PRODUCTS S.A., Neuchatel (CH)

(72) Inventors: Ana Dimitrijevic, Auvernier (CH); Cesare Lorenzetti, Boudry (CH); Aleksander Lowinski, Epalinges (CH)

(21) Appl. No.: 19/151,653

(22) PCT Filed: Jan. 31, 2024
(86) PCT No.: PCT/EP2024/052410

§ 371 Date: Jul. 29, 2025

(30) Foreign Application Priority Data
Jan. 31, 2023 (EP) 23154332.3

(51) Int. Cl. B32B 38/04; B32B 3/26; B32B 25/06

(52) U.S. Cl. CPC B32B 38/04; B32B 3/266; B32B 25/06; B32B 2038/047; B32B 2307/31; B32B 2307/7265; B32B 2439/00

(57) ABSTRACT

There is provided a method of manufacturing a web of multi-layer material (174; 374; 474), the method comprising providing a web of cellulosic material (112). The method also comprises perforating the web of cellulosic material (112) to form a perforated web of cellulosic material. The method also comprises applying a polymeric material to a surface of the perforated web of cellulosic material to form a web of multi-layer material (174; 374; 474), the web of multi-layer material (174; 374; 474) having a perforated first layer (200) comprising the cellulosic material and a second layer (206; 406) comprising the polymeric material. The layer of polymeric material covers, infills, or covers and infills the perforations on the surface of the web of cellulosic material to which the polymeric material is applied.

The present invention relates to methods and apparatus for manufacturing webs of multi-layer material.

It is known to wrap containers of consumer goods in an outer wrapper to protect the containers until they are purchased by a consumer. For example, single packs of cigarettes and other aerosol-generating articles may be enclosed by an outer wrapper that is removed by a consumer upon first accessing the articles within the pack. Similarly, bundles of such packs may be bound together by an outer wrapper that is removed by a consumer when removing packs from the bundle.

Typically, such wrappers are formed from plastic materials such as biaxially oriented polypropylene (BOPP) film to provide moisture barrier protection to the enclosed consumer goods. However, to provide more sustainable and environmentally-friendly packaging it would be desirable to provide an alternative material for forming such outer wrappers that reduces the plastic content of the wrappers without diminishing the moisture barrier properties.

According to present disclosure there is provided a method of manufacturing a web of multi-layer material. The method may comprise providing a web of cellulosic material. The method may comprise perforating the web of cellulosic material to form a perforated web of cellulosic material. The method may comprise applying a polymeric material to a surface of the perforated web of cellulosic material to form a web of multi-layer material, the web of multi-layer material having a perforated first layer comprising the cellulosic material and a second layer comprising the polymeric material.

According to a first aspect of the present disclosure there is provided a method of manufacturing a web of multi-layer material, the method comprising providing a web of cellulosic material. The method also comprises perforating the web of cellulosic material to form a perforated web of cellulosic material. The method also comprises applying a polymeric material to a surface of the perforated web of cellulosic material to form a web of multi-layer material, the web of multi-layer material having a perforated first layer comprising the cellulosic material and a second layer comprising the polymeric material.

Advantageously, the web of cellulosic material may form a base layer of the web of multi-layer material. Advantageously, the cellulosic material may facilitate a significant reduction in the plastic content of the web of multi-layer material when compared to known materials for forming wrappers, such as biaxially oriented polypropylene (BOPP) films.

Advantageously, applying a layer of a polymeric material to a surface of the cellulosic material may provide the web of multi-layer material with desired moisture barrier properties. In particular, the layer of polymeric material may provide the web of multi-layer material with moisture barrier properties comparable to those of known materials for forming wrappers, such as biaxially oriented polypropylene (BOPP) films.

Advantageously, perforating the web of cellulosic material may facilitate removal of a wrapper formed from the web of multi-layer material. For example, the perforations in the web of cellulosic material may form a tear line or a tear strip in a wrapper formed from the web of multi-later material.

Advantageously, perforating the web of cellulosic material prior to the step of applying a polymeric material to a surface of the web of cellulosic material reduces or prevents the risk of the perforations compromising a moisture barrier formed by the layer of polymeric material. In particular, the layer of polymeric material may cover, infill, or cover and infill the perforations on the surface of the web of cellulosic material to which the polymeric material is applied.

Preferably, the web of cellulosic material comprises a first side and a second side opposite the first side. The step of perforating the web of cellulosic material may comprise perforating the web of cellulosic material from the first side, and the step of applying a polymeric material may comprise applying the polymeric material to the second side of the web of cellulosic material.

Advantageously, forming the perforations from an opposite side of the web of cellulosic material to the side on which the polymeric material is applied may facilitate an improved visual appearance of a wrapper formed from the web of multi-layer material. For example, when the web of multi-layer material is used to form a wrapper, it may be desirable to position a moisture barrier formed by the layer of polymeric material on an inner surface of the wrapper. In this case, the side of the web of cellulosic material from which the perforations are formed defines an outer surface of the wrapper. Advantageously, positioning the side of the web of cellulosic material from which the perforations are formed as the outer surface of the wrapper may optimise a visual appearance of the perforations.

The web of cellulosic material may comprise at least one of text, graphics, logos, and indicia on at least one of the first side and the second side. Preferably, the web of cellulosic material comprises the at least one of text, graphics, logos, and indicia on at least the first side. As discussed above, when the web of multi-layer material is used to form a wrapper, it may be desirable to position a moisture barrier formed by the layer of polymeric material on an inner surface of the wrapper. In this case, the second side forms the inner surface of the wrapper and the first side forms an outer surface of the wrapper. Advantageously, positioning the at least one of text, graphics, logos, and indicia on at least the first side allows the at least one of text, graphics, logos, and indicia to be viewed from outside of the wrapper.

The step of providing a web of cellulosic material may comprise providing a web of cellulosic material that already comprises at least one of text, graphics, logos, and indicia on a surface of the web of cellulosic material.

The method may further comprise a step of printing the at least one of text, graphics, logos, and indicia on at least one of the first side and the second side of the web of cellulosic material.

Advantageously, including the printing step in the method of manufacturing a web of multi-layer material may simplify the manufacturing process by combining multiple steps into a single process.

The printing step may be carried out before the perforating step. Advantageously, performing the printing step before the perforating step may facilitate registration of the perforations with the at least one of text, graphics, logos, and indicia printed on the web of cellulosic material.

The printing step may comprise at least one of lithographic printing, flexographic printing, digital printing, and gravure printing.

The step of perforating the web of cellulosic material may comprise perforating the web of cellulosic material using a rotary die cutter.

The step of applying the polymeric material may comprise applying the polymeric material to the cellulosic material using a slot-die coater. Preferably, the slot-die coater is a rotating bar slot-die coater.

Advantageously, the present inventors have recognised that a rotating bar slot-die coater may facilitate the deposition at high process speeds of a uniform second layer of the polymeric material having a relatively low thickness. For example, the use of a rotating bar slot-die coater may facilitate the deposition of a uniform second layer of the polymeric material having a thickness of less than 20 micrometres at a web speed of at least 100 metres per minute.

Preferably, the rotating bar slot-die coater comprises at least one chilled roller. Advantageously, the at least one chilled roller may facilitate rapid cooling and solidification of the polymeric material in embodiments in which the polymeric material is a hot-melt polymeric material deposited in a molten state on the web of cellulosic material by the rotating bar slot-die coater.

Preferably, the at least one chilled roller comprises a water-cooling circuit arranged inside the chilled roller. The water-cooling circuit may have a spiral shape.

Preferably, the second layer comprising the polymeric material is a moisture barrier layer. Advantageously, the moisture barrier layer may provide the web of multi-layer material with moisture barrier properties comparable to those of known materials for forming wrappers, such as biaxially oriented polypropylene (BOPP) films.

As used herein, the term “moisture barrier layer” refers to a layer that has a water vapour or moisture transmission rate (WVTR) of equal to or less than 20 grams per square meter per 24 hours at 38 degrees Celsius and 90 percent relative humidity when determined by ISO 2528:1995 or ASTM F3299. Preferably, a moisture barrier layer of a multi-layer material of the present invention has a WVTR of less than 10 grams per square meter per 24 hours at 38 degrees Celsius and 90 percent relative humidity.

The polymeric material may comprise at least one of: an homopolymer of ethylene, propylene, 1-butene, isobutene, 1-octene, 1-hexene; a copolymer of at least two monomers among ethylene, propylene, 1-butene, isobutene, 1-octene, 1-hexene, styrene; a copolymer of ethylene and vinyl acetate; a copolymer of ethylene and an ester of acrylic or methacrylic acid; a copolymer of ethylene and acrylic or methacrylic acid; a copolymer of styrene and ethylene and propylene; an hydrogenated copolymer of styrene and butadiene; and hydrogenated copolymer of styrene and isoprene; a copolymer of styrene and isobutene; and a wax.

The polymeric material may comprise a polymer component in an amount of between 50 percent and 90 percent by weight of the polymeric material. The polymeric component may comprise at least one of a polymer of ethylene, a polymer of propylene, a copolymer of ethylene, a copolymer of propylene, a polyethylene plastomer, a polypropylene plastomer, and amorphous polypropylene. The polymeric material may comprise a wax in an amount of between 2 percent and 20 percent by weight of the polymeric material. The wax may comprise at least one of paraffin wax and polyethylene wax. The polymeric material may comprise a tackifier in an amount of less than or equal to 48 percent by weight of the polymeric material. The tackifier may comprise a hydrogenated hydrocarbon resin. The polymeric material may comprise an antioxidant in an amount of less than or equal to 1 percent by weight of the polymeric material.

The antioxidant may comprise at least one of a phenolic antioxidant, a phosphite antioxidant, vitamin E, a hindered amine stabilizer, and hydroxylamine stabilizer.

An exemplary polymeric material may comprise a propylene homopolymer in an amount of 70 percent by weight of the polymeric material, a propylene-ethylene-copolymer in an amount of 14 percent by weight of the polymeric material, a hydrogenated aromatic hydrocarbon resin in an amount of 10 percent by weight of the polymeric material, and a paraffin wax in an amount of 6 percent by weight of the polymeric material. Preferably, the paraffin wax has a melting point of approximately 60 degrees Celsius, such as between 55 degrees Celsius and 65 degrees Celsius.

The polymeric material may comprise a polymer component in an amount of between 20 percent and 60 percent by weight of the polymeric material. The polymeric component may comprise at least one of a polymer of ethylene, a polymer of propylene, a copolymer of ethylene, a copolymer of propylene, a polyethylene plastomer, a polypropylene plastomer, amorphous polypropylene, a polyethylene-co-vinyl-acetate copolymer, a copolymer of ethylene and acrylic, a copolymer of ethylene and methacrylic acid, a polyisobutylene, and a copolymer of styrene with one or more monomers selected from butadiene, isobutylene, and isoprene, a hydrogenated copolymer of styrene with one or more monomers selected from butadiene, isobutylene, and isoprene. The polymeric material may comprise a wax in an amount of between 20 percent and 50 percent by weight of the polymeric material. The wax may comprise at least one of paraffin wax, microcrystalline wax, and polyethylene wax. The polymeric material may comprise a tackifier in an amount of less than or equal to 60 percent by weight of the polymeric material. The tackifier may comprise a hydrocarbon resin, a hydrogenated hydrocarbon resin, a polyterpenic resin, a hydrogenated polyterpenic resin, a rosin ester, and a hydrogenated rosin ester. The polymeric material may comprise an antioxidant in an amount of less than or equal to 1 percent by weight of the polymeric material. The antioxidant may comprise at least one of a phenolic antioxidant, a phosphite antioxidant, vitamin E, an hindered amine stabilizer, and hydroxylamine stabilizer.

A further exemplary polymeric material comprises propylene-ethylene-copolymer plastomer in an amount of 45 percent by weight of the polymeric material, a hydrogenated aromatic hydrocarbon resin in an amount of 15 percent by weight of the polymeric material, and a paraffin wax in an amount of 40 percent by weight of the polymeric material. Preferably, the paraffin wax has a melting point of approximately 60 degrees Celsius, such as between 55 degrees Celsius and 65 degrees Celsius.

A yet further exemplary polymeric material comprises a low molecular weight polyethylene in an amount of 45 percent by weight of the polymeric material, a hydrogenated aromatic hydrocarbon resin in an amount of 10 percent by weight of the polymeric material, a Fischer-Tropsch polyethylene wax in an amount of 10 percent by weight of the polymeric material, and a paraffin wax in an amount of 35 percent by weight of the polymeric material. Preferably, the paraffin wax has a melting point of approximately 60 degrees Celsius, such as between 55 degrees Celsius and 65 degrees Celsius.

The polymeric material may be a first polymeric material. The method may further comprise a step of applying a second polymeric material to the perforated web of cellulosic material.

Advantageously, applying a second polymeric material may provide the multi-layer material with one or more desired properties. For example, the second layer comprising the first polymeric material may be a moisture barrier layer, as described above. The second polymeric material may be a heat sealable material.

The step of applying the second polymeric material may be carried out before the step of applying the first polymeric material. Preferably, the step of applying the second polymeric material is carried out after the step of applying the first polymeric material.

The step of applying the second polymeric material may comprise applying the second polymeric material to form a third layer comprising the second polymeric material. The third layer comprising the second polymeric material may be a heat sealable layer.

As used herein, the term “heat sealable layer” refers to a layer capable of fusion bonding by conventional indirect heating means which generates sufficient heat on at least one multi-layer material contact surface for conduction to a contiguous multi-layer material contact surface and formation of a bond interface between the surfaces without loss of the multi-layer material integrity. The bond interface between contiguous surfaces preferably has sufficient physical strength to withstand packaging processes and subsequent handling. Heat sealable layers may be designed to meet different conditions of expected use and various heat sealable layers' formulations are known in the art and may be employed with the present invention.

Preferably, a heat sealable layer has a melting point measured according to differential scanning calorimetry (DSC) lower than 100 degrees Celsius. More preferably, a heat sealable layer has a melting point measured according to DSC lower than 80 degrees Celsius.

Preferably, the second layer comprising the first polymeric material is applied to the second side of the web of cellulosic material, as described above. Preferably, the second layer covers substantially the entire second side of the web of cellulosic material. Covering the entire second side of the web of cellulosic material may be particularly advantageous in embodiments in which the second layer is a moisture barrier layer.

The third layer comprising the second polymeric material may be applied to the second side of the web of cellulosic material. The third layer comprising the second polymeric material may at least partially overlap the second layer comprising the first polymeric material.

The third layer comprising the second polymeric material may be applied to the first side of the web of cellulosic material.

The third layer may cover substantially the entire first side or second side of the web of cellulosic material. Alternatively, the third layer may be applied to the first side or the second side of the web of cellulosic material in a repeating pattern.

Instead of applying the second polymeric material separately from the first polymeric material, the step of applying a polymeric a polymeric material to a surface of the perforated web of cellulosic material to form a web of multi-layer material may comprise simultaneously applying the first polymeric material and the second polymeric material to a surface of the perforated web of cellulosic material to form the web of multi-layer material. In such embodiments, the web of multi-layer material has a perforated first layer comprising the cellulosic material and a second layer comprising both the first polymeric material and the second polymeric material.

Advantageously, simultaneously applying the first and second polymeric materials may simplify the process of forming the multi-layer material, particularly in embodiments in which the first and second polymeric materials are applied to the same side of the web of cellulosic material.

The step of simultaneously applying the first polymeric material and the second polymeric material to a surface of the perforated web of cellulosic material to form the web of multi-layer material may comprise applying a polymeric mixture to a surface of the perforated web of cellulosic material to form the web of multi-layer material, wherein the polymeric mixture comprises the first polymeric material and the second polymeric material.

The second polymeric material may comprise at least one of an homopolymer of ethylene, propylene, 1-butene, isobutene, 1-octene, 1-hexene; a copolymer of at least two monomers among ethylene, propylene, 1-butene, isobutene, 1-octene, 1-hexene, styrene; a copolymer of ethylene and vinyl acetate; a copolymer of ethylene and an ester of acrylic or methacrylic acid; a copolymer of ethylene and acrylic or methacrylic acid; a copolymer of styrene and ethylene and propylene; an hydrogenated copolymer of styrene and butadiene; and hydrogenated copolymer of styrene and isoprene; a copolymer of styrene and isobutene;

It is important to note that although the ingredients of the first and second polymeric materials can be very similar, the choice of the most appropriate grade can create a distinction among their respective thermal or rheological properties. As a matter of fact, different grades of polyethylene can be selected to provide a melting point as high as 130 degrees Celsius or as low as 70 degrees Celsius.

The method may further comprise a step of slitting the web of multi-layer material to form a plurality of webs of multi-layer material. Advantageously, this may facilitate the use of a single process line to form multiple webs of the multi-layer material. The step of slitting the web of multi-layer material to form a plurality of webs of multi-layer material may comprise slitting the web of multi-layer material to form two, three, four, five or six webs of multi-layer material.

Preferably, the web of cellulosic material comprises a web of paper or a web of paperboard.

The web of cellulosic material may have a grammage of at least 30 grams per square metre, at least 40 grams per square metre, at least 50 grams per square metre, at least 60 grams per square metre, at least 70 grams per square metre, at least 80 grams per square metre, at least 90 grams per square metre, at least 100 grams per square metre, at least 110 grams per square metre, at least 120 grams per square metre, at least 130 grams per square metre, at least 140 grams per square metre, or at least 150 grams per square metre.

The web of cellulosic material may have a grammage of less than or equal to 270 grams per square metre, less than or equal to 250 grams per square metre, less than or equal to 240 grams per square metre, less than or equal to 230 grams per square metre, less than or equal to 220 grams per square metre, less than or equal to 210 grams per square metre, less than or equal to 200 grams per square metre, less than or equal to 190 grams per square metre, less than or equal to 180 grams per square metre, less than or equal to 170 grams per square metre, less than or equal to 160 grams per square metre, less than or equal to 150 grams per square metre, less than or equal to 140 grams per square metre, less than or equal to 130 grams per square metre, or less than or equal to 120 grams per square metre.

The web of cellulosic material may have a grammage of between 40 grams per square metre and 120 grams per square metre. The web of cellulosic material may have a grammage of between 150 grams per square metre and 250 grams per square metre.

The step of providing a web of cellulosic material may comprise providing a web of cellulosic material already comprising a coating on at least a portion of the web of cellulosic material. Generally speaking, the coating may comprise a polymeric material and can be applied by dispersion coating during the paper manufacturing process. Suitable coating materials may include at least one of polyvinyl alcohol, emulsions or dispersions of poly-styrene-co-butadiene, or other copolymers of styrene and acrylic or methacrylic monomers, and fillers such as kaolin, calcium carbonate, talcum and the like.

The step of providing a web of cellulosic material may comprise providing a web of a laminate material comprising at least one layer of cellulosic material. Preferably, the laminate material comprises at least one layer of a non-cellulosic material. The non-cellulosic material may comprise a non-cellulosic polymer. The at least one layer of non-cellulosic material may comprise a non-cellulosic polymeric film. The non-cellulosic polymeric film may comprise at least one of an oriented polypropylene film, an oriented polyethylene terephthalate film. Preferably, these films have a thickness of between 6 micrometres and 15 micrometres.

The second layer comprising the polymeric material or the polymeric mixture may have a grammage of at least 8 grams per square metre, at least 9 grams per square metre, at least 10 grams per square metre, at least 11 grams per square metre, at least 12 grams per square metre, at least 13 grams per square metre, or at least 14 grams per square metre.

The second layer comprising the polymeric material or the polymeric mixture may have a grammage of less than or equal to 15 grams per square metre, less than or equal to 14 grams per square metre, less than or equal to 13 grams per square metre, less than or equal to 12 grams per square metre, less than or equal to 11 grams per square metre, less than or equal to 8 grams per square metre, or less than or equal to 6 grams per square metre.

The second layer comprising the polymeric material or the polymeric mixture may have a grammage of between 8 grams per square metre and 15 grams per square metre.

The second layer comprising the polymeric material or the polymeric mixture may have a thickness of less than or equal to 20 micrometres, less than or equal to 19 micrometres, less than or equal to 18 micrometres, less than or equal to 17 micrometres, less than or equal to 16 micrometres, less than or equal to 15 micrometres, less than or equal to 14 micrometres, less than or equal to 13 micrometres, less than or equal to 12 micrometres, less than or equal to 11 micrometres, or less than or equal to 10 micrometres.

The second layer comprising the polymeric material or the polymeric mixture may have a thickness of at least 6 micrometres, at least 9 micrometres, at least 10 micrometres, at least 11 micrometres, at least 12 micrometres, at least 13 micrometres, at least 14 micrometres, or at least 15 micrometres.

The step of applying the polymeric material or the step of applying the polymeric mixture may comprise applying the polymeric material or the polymeric mixture at a temperature of less than or equal to 200 degrees Celsius, less than or equal to 190 degrees Celsius, less than or equal to 180 degrees Celsius, less than or equal to 170 degrees Celsius, less than or equal to 160 degrees Celsius, less than or equal to 150 degrees Celsius, less than or equal to 140 degrees Celsius, less than or equal to 130 degrees Celsius, less than or equal to 120 degrees Celsius, or less than or equal to 110 degrees Celsius.

The step of applying the polymeric material or the step of applying the polymeric mixture may comprise applying the polymeric material or the polymeric mixture at a temperature of at least 100 degrees Celsius, at least 110 degrees Celsius, at least 120 degrees Celsius, at least 130 degrees Celsius, at least 140 degrees Celsius, at least 150 degrees Celsius, at least 160 degrees Celsius, at least 170 degrees Celsius, at least 180 degrees Celsius, or at least 190 degrees Celsius.

The step of applying the polymeric material or the step of applying the polymeric mixture may comprise applying the polymeric material or the polymeric mixture at a dynamic viscosity of less than 40000 millipascal seconds, preferably less than 20000 millipascal seconds, preferably less than 10000 millipascal seconds, preferably less than 5000 millipascal seconds.

During the step of applying the polymeric material or the step of applying the polymeric mixture, the method may comprise advancing the perforated web of cellulosic material at a speed of at least 100 metres per minute, at least 110 metres per minute, at least 120 metres per minute, at least 130 metres per minute, at least 140 metres per minute, at least 150 metres per minute, at least 160 metres per minute, at least 170 metres per minute, at least 180 metres per minute, at least 190 metres per minute, at least 200 metres per minute, at least 210 metres per minute, at least 220 metres per minute, at least 230 metres per minute, or at least 240 metres per minute.

During the step of applying the polymeric material or the step of applying the polymeric mixture, the method may comprise advancing the perforated web of cellulosic material at a speed of less than or equal to 300 meters per minute, less than or equal to 240 meters per minute, less than or equal to 230 meters per minute, less than or equal to 220 meters per minute, less than or equal to 210 meters per minute, or less than or equal to 200 meters per minute.

According to a second aspect of the present invention, there is provided a web of multi-layer material manufactured using a method of the first aspect of the present invention, according to any of the examples or embodiments described herein.

According to the present disclosure, there is provided a method of manufacturing a package of consumer goods. The method may comprise forming a web of multi-layer material using a method according to the first aspect of the present invention. The method may comprise providing a web of multi-layer material using a method according to the first aspect of the present invention. The method may comprise cutting a laminar blank from the web of multi-layer material. The method may comprise folding the laminar blank to form a package of consumer goods.

According to a third aspect of the present invention there is provided a method of manufacturing a package of consumer goods. The method may comprise forming a web of multi-layer material using a method of the first aspect of the present invention, according to any of the examples or embodiments described herein. Alternatively, the method may comprise providing a web of multi-layer material using a method of the first aspect of the present invention, according to any of the examples or embodiments described herein. The method also comprises cutting a laminar blank from the web of multi-layer material and folding the laminar blank to form a package of consumer goods.

Preferably, the second layer comprising the polymeric material forms an inner surface of the folded laminar blank. Advantageously, positioning the polymeric material on an inner surface of the folded laminar blank may reduce the risk of damage to the second layer comprising the polymeric material during handling of the package of consumer goods. This may be particularly advantageous in embodiments in which the polymeric material is a moisture barrier material and the second layer comprising the polymeric material forms a moisture barrier layer.

Preferably, the laminar blank comprises the second polymeric material or the polymeric mixture described herein, wherein the second polymeric material or the polymeric mixture comprises a heat sealable material. Advantageously, the heat sealable material may retain the laminar blank in a folded configuration. Advantageously, the heat sealable material may seal one or more consumer goods inside the folded laminar blank.

Preferably, the method comprises a step of applying heat to the folded laminar blank to form at least one bond interface between adjacent surfaces of the folded laminar blank.

Based on the particular packaging application and how the laminar blank is folded to form the package of consumer goods, the second polymeric material may be provided on the same side of the web of cellulosic material as the first polymeric material or on the opposite side of the web of cellulosic material. In embodiments in which the second polymeric material is provided on the same side of the web of cellulosic material as the first polymeric material, the first and second polymeric materials may be applied separately or simultaneously as a polymeric mixture, as described herein.

Preferably, the method comprises a step of providing one or more consumer goods, wherein the step of folding the laminar blank comprises folding the laminar blank around the one or more consumer goods.

The one or more consumer goods may comprise a plurality of aerosol-generating articles. The web of multi-layer material forming the laminar blank may comprise the first polymeric material and the second polymeric material provided on the same side of the web of cellulosic material and forming an inner surface of the folded laminar blank. The first polymeric material and the second polymeric material may be provided separately on the web of cellulosic material or provided together as a polymeric mixture.

The one or more consumer goods may comprise a bundle of packages of aerosol-generating articles. At least one of the packages of aerosol-generating article may be manufactured using a method according to the present invention. The web of multi-layer material forming the laminar blank may comprise the second polymeric material provided on a first side of the web of cellulosic material and the first polymeric material provided on the second side of the web of cellulosic material, wherein the second side of the web of cellulosic material forms an inner surface of the folded laminar blank. Preferably, the second polymeric material is provided on only part of the first side of the web of cellulosic material. Preferably, the second polymeric material is provided only on one or more portions of the laminar blank that overlap one or more other portions of the laminar blank when the laminar blank is folded.

According to a fourth aspect of the present invention, there is provided a package of consumer goods manufactured using a method of the third aspect of the present invention, according to any of the examples or embodiments described herein.

According to the present disclosure there is provided a multi-layer material. The multi-layer material may comprise a first layer comprising a cellulosic material. The multi-layer material may comprise a second layer comprising a polymeric material. The multi-layer material may comprise a plurality of perforations. Each perforation may extend only through the first layer.

According to a fifth aspect of the present invention, there is provided a multi-layer material. The multi-layer material comprises a first layer comprising a cellulosic material. The multi-layer material also comprises a second layer comprising a polymeric material. The multi-layer material also comprise a plurality of perforations, wherein each perforation extends only through the first layer.

Preferably, the first layer comprising the cellulosic material comprises a first side and a second side opposite the first side, wherein the perforations are formed from the first side of the first layer, and wherein the second layer comprising the polymeric material overlies the second side of the first layer.

Advantageously, forming the perforations from an opposite side of the first layer comprising the cellulosic material to the side on which the polymeric material is applied may facilitate an improved visual appearance of a wrapper formed from the multi-layer material. For example, when the multi-layer material is used to form a wrapper, it may be desirable to position a moisture barrier formed by the layer of polymeric material on an inner surface of the wrapper. In this case, the side of the first layer comprising the cellulosic material from which the perforations are formed defines an outer surface of the wrapper. Advantageously, positioning the side of the first layer comprising the cellulosic material from which the perforations are formed as the outer surface of the wrapper may optimise a visual appearance of the perforations.

The first layer comprising the cellulosic material comprises at least one of text, graphics, logos, and indicia on the first side.

The multi-layer material of the fifth aspect of the present invention may comprise any of the optional or preferred features described above with respect to a web of material manufactured according to the method of the first aspect of the present invention. The multi-layer material of the fifth aspect of the present invention may be manufactured using a method according to the first aspect of the present invention, in accordance with any of the examples or embodiments described herein.

According to a sixth aspect of the present invention there is provided a package of consumer goods, the package comprising a folded laminar blank formed from a multi-layer material of the fifth aspect of the present invention, in accordance with any of the examples or embodiments described herein. The package also comprises one or more consumer goods contained within the folded laminar blank.

The package may comprise any of the optional or preferred features according to the third or fourth aspects of the present invention. The package may be manufactured using a method of the third aspect of the present invention in accordance with any of the examples or embodiments described herein.

According to the present disclosure there is provided an apparatus for manufacturing a web of multi-layer material. The apparatus may comprise a feeding r for feeding a web of cellulosic material. The apparatus may comprise a perforating station for perforating the web of cellulosic material to form a perforated web of cellulosic material. The apparatus may comprise a polymer application station for applying a polymeric material to a surface of the perforated web of cellulosic material to form a web of multi-layer material, the web of multi-layer material having a perforated first layer comprising the cellulosic material and a second layer comprising the polymeric material.

According to a seventh aspect of the present invention there is provided an apparatus for manufacturing a web of multi-layer material. The apparatus comprises a feeding station for feeding a web of cellulosic material. The apparatus also comprises a perforating station for perforating the web of cellulosic material to form a perforated web of cellulosic material. The apparatus also comprises a polymer application station for applying a polymeric material to a surface of the perforated web of cellulosic material to form a web of multi-layer material, the web of multi-layer material having a perforated first layer comprising the cellulosic material and a second layer comprising the polymeric material.

The apparatus may comprise any of the optional or preferred features described above with respect to the first aspect of the present invention. The apparatus may be configured to carry out a method of the first aspect of the present invention in accordance with any of the examples or embodiments described herein.

Preferably, the perforating station is arranged to perforate a first side of the web of cellulosic material, wherein the polymer application station is arranged to apply the polymeric material to a second side of the web of cellulosic material, and wherein the second side is opposite the first side. Preferably, the apparatus comprises a turnbar positioned between the perforating station and the polymer application station. Advantageously, a turnbar reverses the orientation of the web of cellulosic material, which may facilitate perforation and polymer application on different sides of the web of cellulosic material.

The apparatus may comprise a printing station arranged to print at least one of text, graphics, logos, and indicia on the first side of the web of cellulosic material. The printing station may be positioned between the feeding station and the perforating station. The printing station may comprise at least one of a lithographic printer, a flexographic printer, a digital printer, and a gravure printer.

The perforating station may comprise a rotary die cutter.

The polymer application station may comprise a slot-die coater. Preferably, the slot-die coater is a rotating bar slot-die coater. Preferably, the rotating bar slot-die coater comprises at least one chilled roller. Preferably, the at least one chilled roller comprises a water-cooling circuit arranged inside the chilled roller. Preferably, the cooling circuit has a spiral shape.

The polymer application station may be a first polymer application station for applying a first polymeric material. The apparatus may further comprise a second polymer application station for applying a second polymeric material to form a third layer comprising the second polymeric material.

Preferably, the second polymer application station is positioned after the first polymer application station. The apparatus may comprise a turnbar positioned between the first polymer application station and the second polymer application station. The turnbar may be use to reverse the orientation of the web of cellulosic material where it is desirable to apply the first polymeric material and the second polymeric material to opposite sides of the web of cellulosic material. The turnbar may be omitted for processes in which it is desirable to apply the first polymeric material and the second polymeric material to the same side of the web of cellulosic material. The apparatus may be provided with a removable turnbar positioned between the first polymer application station and the second polymer application, wherein the turnbar may be removed or inserted depending on the particular process for which the apparatus is to be used and whether it is desirable to apply the second polymeric material to the first side or the second side of the web of cellulosic material.

The second polymer application station may comprise a pattern coater. Advantageously, a pattern coater may be used to apply the second polymeric material only to one or more portions of the web of cellulosic material. This may be particularly advantageous in embodiments in which the second polymeric material is a heat sealable material or other adhesive.

The apparatus may comprise a slitter arranged to slit the web of multi-layer material into a plurality of webs of multi-layer material.

According to an eighth aspect of the present invention, there is provided an apparatus for manufacturing a package of consumer goods. The apparatus comprises a web forming apparatus comprising an apparatus of the seventh aspect of the present invention, in accordance with any of the examples and embodiments described herein. The apparatus also comprises a cutting station for receiving a web of multi-layer material from the web forming apparatus and for cutting a laminar blank from the web of multi-layer material. The apparatus also comprises a folding station for folding the laminar blank to form a package of consumer goods.

The apparatus may comprise any of the optional or preferred features described above with respect to the third aspect of the present invention. The apparatus may be configured to carry out a method of the third aspect of the present invention in accordance with any of the examples or embodiments described herein.

Preferably, the folding station is arranged to fold the laminar blank so that the second layer comprising the polymeric material forms an inner surface of the folded laminar blank.

Preferably, the apparatus comprises a sealing station arranged to apply heat to the folded laminar blank to form at least one bond interface between adjacent surfaces of the folded laminar blank.

Preferably, the folding station is arranged to receive one or more consumer goods and to fold the laminar blank around the one or more consumer goods.

According to the present disclosure, there is provided a method of manufacturing a web of multi-layer material. The method may comprise providing a web of cellulosic material. The method may comprise using a rotating bar slot-die coater to apply a moisture barrier material to a surface of the web of cellulosic material to form a web of multi-layer material. The web of multi-layer material may have a first layer comprising the cellulosic material and a second layer, wherein the second layer is a moisture barrier layer comprising the moisture barrier material.

According to a ninth aspect of the present invention, there is provided a method of manufacturing a web of multi-layer material. The method comprises providing a web of cellulosic material. The method also comprises using a rotating bar slot-die coater to apply a moisture barrier material to a surface of the web of cellulosic material to form a web of multi-layer material. The web of multi-layer material has a first layer comprising the cellulosic material and a second layer, wherein the second layer is a moisture barrier layer comprising the moisture barrier material.

Advantageously, the present inventors have recognised that a rotating bar slot-die coater may facilitate the deposition at high process speeds of a uniform layer of the moisture barrier material having a relatively low thickness. For example, the use of a rotating bar slot-die coater may facilitate the deposition of a uniform layer of the moisture barrier material having a thickness of less than 20 micrometres at a web speed of at least 100 metres per minute.

Preferably, the rotating bar slot-die coater comprises at least one chilled roller. Advantageously, the at least one chilled roller may facilitate rapid cooling and solidification of the polymeric material in embodiments in which the polymeric material is a hot-melt polymeric material deposited in a molten state on the web of cellulosic material by the rotating bar slot-die coater.

Preferably, the at least one chilled roller comprises a water-cooling circuit arranged inside the chilled roller. The water-cooling circuit may have a spiral shape.

The moisture barrier material may comprise at least one of: an homopolymer of ethylene, propylene, 1-butene, isobutene, 1-octene, 1-hexene; a copolymer of at least two monomers among ethylene, propylene, 1-butene, isobutene, 1-octene, 1-hexene, styrene; a copolymer of ethylene and vinyl acetate; a copolymer of ethylene and an ester of acrylic or methacrylic acid; a copolymer of ethylene and acrylic or methacrylic acid; a copolymer of styrene and ethylene and propylene; an hydrogenated copolymer of styrene and butadiene; and hydrogenated copolymer of styrene and isoprene; a copolymer of styrene and isobutene; and a wax . . . .

The moisture barrier material may comprise a polymer component in an amount of between 50 percent and 90 percent by weight of the moisture barrier material. The polymeric component may comprise at least one of a polymer of ethylene, a polymer of propylene, a copolymer of ethylene, a copolymer of propylene, a polyethylene plastomer, a polypropylene plastomer, and amorphous polypropylene. The moisture barrier material may comprise a wax in an amount of between 2 percent and 20 percent by weight of the moisture barrier material. The wax may comprise at least one of paraffin wax and polyethylene wax. The moisture barrier material may comprise a tackifier in an amount of less than or equal to 48 percent by weight of the moisture barrier material. The tackifier may comprise a hydrogenated hydrocarbon resin. The moisture barrier material may comprise an antioxidant in an amount of less than or equal to 1 percent by weight of the moisture barrier material. The antioxidant may comprise at least one of a phenolic antioxidant and a phosphite antioxidant.

An exemplary moisture barrier material may comprise a propylene homopolymer in an amount of 70 percent by weight of the moisture barrier material, a propylene-ethylene-copolymer in an amount of 14 percent by weight of the moisture barrier material, a hydrogenated aromatic hydrocarbon resin in an amount of 10 percent by weight of the moisture barrier material, and a paraffin wax in an amount of 6 percent by weight of the moisture barrier material. Preferably, the paraffin wax has a melting point of approximately 60 degrees Celsius, such as between 55 degrees Celsius and 65 degrees Celsius.

The moisture barrier material may comprise a polymer component in an amount of between 20 percent and 60 percent by weight of the moisture barrier material. The polymeric component may comprise at least one of a polymer of ethylene, a polymer of propylene, a copolymer of ethylene, a copolymer of propylene, a polyethylene plastomer, a polypropylene plastomer, amorphous polypropylene, a polyethylene-co-vinyl-acetate copolymer, a copolymer of ethylene and acrylic, a copolymer of ethylene and methacrylic acid, a polyisobutylene, and a copolymer of styrene with one or more monomers selected from butadiene, isobutylene, and isoprene, a hydrogenated copolymer of styrene with one or more monomers selected from butadiene, isobutylene, and isoprene. The moisture barrier material may comprise a wax in an amount of between 20 percent and 50 percent by weight of the moisture barrier material. The wax may comprise at least one of paraffin wax, microcrystalline wax, and polyethylene wax. The moisture barrier material may comprise a tackifier in an amount of less than or equal to 60 percent by weight of the moisture barrier material. The tackifier may comprise a hydrocarbon resin, a hydrogenated hydrocarbon resin, a polyterpenic resin, a hydrogenated polyterpenic resin, a rosin ester, and a hydrogenated rosin ester. The moisture barrier material may comprise an antioxidant in an amount of less than or equal to 1 percent by weight of the moisture barrier material. The antioxidant may comprise at least one of a phenolic antioxidant, a phosphite antioxidant, and vitamin E.

A further exemplary moisture barrier material comprises propylene-ethylene-copolymer plastomer in an amount of 45 percent by weight of the moisture barrier material, a hydrogenated aromatic hydrocarbon resin in an amount of 15 percent by weight of the moisture barrier material, and a paraffin wax in an amount of 40 percent by weight of the moisture barrier material. Preferably, the paraffin wax has a melting point of approximately 60 degrees Celsius, such as between 55 degrees Celsius and 65 degrees Celsius.

A yet further exemplary moisture barrier material comprises a low molecular weight polyethylene in an amount of 45 percent by weight of the moisture barrier material, a hydrogenated aromatic hydrocarbon resin in an amount of 10 percent by weight of the moisture barrier material, a Fischer-Tropsch polyethylene wax in an amount of 10 percent by weight of the moisture barrier material, and a paraffin wax in an amount of 35 percent by weight of the moisture barrier material. Preferably, the paraffin wax has a melting point of approximately 60 degrees Celsius, such as between 55 degrees Celsius and 65 degrees Celsius.

Preferably, the web of cellulosic material comprises a web of paper or a web of paperboard.

The web of cellulosic material may have a grammage of at least 30 grams per square metre, at least 40 grams per square metre, at least 50 grams per square metre, at least 60 grams per square metre, at least 70 grams per square metre, at least 80 grams per square metre, at least 90 grams per square metre, at least 100 grams per square metre, at least 110 grams per square metre, at least 120 grams per square metre, at least 130 grams per square metre, at least 140 grams per square metre, or at least 150 grams per square metre.

The web of cellulosic material may have a grammage of less than or equal to 270 grams per square metre, less than or equal to 250 grams per square metre, less than or equal to 240 grams per square metre, less than or equal to 230 grams per square metre, less than or equal to 220 grams per square metre, less than or equal to 210 grams per square metre, less than or equal to 200 grams per square metre, less than or equal to 190 grams per square metre, less than or equal to 180 grams per square metre, less than or equal to 170 grams per square metre, less than or equal to 160 grams per square metre, less than or equal to 150 grams per square metre, less than or equal to 140 grams per square metre, less than or equal to 130 grams per square metre, or less than or equal to 120 grams per square metre.

The web of cellulosic material may have a grammage of between 40 grams per square metre and 120 grams per square metre. The web of cellulosic material may have a grammage of between 150 grams per square metre and 250 grams per square metre.

The step of providing a web of cellulosic material may comprise providing a web of cellulosic material already comprising a coating on at least a portion of the web of cellulosic material. Generally speaking, those coatings may comprise a polymeric material and can be applied by dispersion coating during the paper manufacturing process. Suitable coating materials may include at least one of polyvinyl alcohol, emulsions or dispersions of poly-styrene-co-butadiene, or other copolymers of styrene and acrylic or methacrylic monomers, and fillers such as kaolin, calcium carbonate, talcum and the like.

The step of providing a web of cellulosic material may comprise providing a web of a laminate material comprising at least one layer of cellulosic material. Preferably, the laminate material comprises at least one layer of a non-cellulosic material. The non-cellulosic material may comprise a non-cellulosic polymer. The at least one layer of non-cellulosic material may comprise a non-cellulosic polymeric film. The non-cellulosic polymeric film may comprise at least one of an oriented polypropylene film, an oriented polyethylene terephthalate film. Preferably, these films have a thickness of between 6 micrometres and 15 micrometres.

The second layer comprising the moisture barrier material may have a grammage of at least 8 grams per square metre, at least 9 grams per square metre, at least 10 grams per square metre, at least 11 grams per square metre, at least 12 grams per square metre, at least 13 grams per square metre, or at least 14 grams per square metre.

The second layer comprising the moisture barrier material may have a grammage of less than or equal to 15 grams per square metre, less than or equal to 14 grams per square metre, less than or equal to 13 grams per square metre, less than or equal to 12 grams per square metre, less than or equal to 11 grams per square metre, less than or equal to 10 grams per square metre, or less than or equal to 9 grams per square metre.

The second layer comprising the moisture barrier material may have a grammage of between 8 grams per square metre and 15 grams per square metre.

The second layer comprising the moisture barrier material may have a thickness of less than or equal to 20 micrometres, less than or equal to 19 micrometres, less than or equal to 18 micrometres, less than or equal to 17 micrometres, less than or equal to 16 micrometres, less than or equal to 15 micrometres, less than or equal to 14 micrometres, less than or equal to 13 micrometres, less than or equal to 12 micrometres, less than or equal to 11 micrometres, or less than or equal to 10 micrometres.

The second layer comprising the moisture barrier material may have a thickness of at least 8 micrometres, at least 9 micrometres, at least 10 micrometres, at least 11 micrometres, at least 12 micrometres, at least 13 micrometres, at least 14 micrometres, or at least 15 micrometres.

The step of applying the moisture barrier material may comprise applying the moisture barrier material at a temperature of less than or equal to 200 degrees Celsius, less than or equal to 190 degrees Celsius, less than or equal to 180 degrees Celsius, less than or equal to 170 degrees Celsius, less than or equal to 160 degrees Celsius, less than or equal to 150 degrees Celsius, less than or equal to 140 degrees Celsius, less than or equal to 130 degrees Celsius, less than or equal to 120 degrees Celsius, or less than or equal to 110 degrees Celsius.

The step of applying the moisture barrier material may comprise applying the moisture barrier material at a temperature of at least 100 degrees Celsius, at least 110 degrees Celsius, at least 120 degrees Celsius, at least 130 degrees Celsius, at least 140 degrees Celsius, at least 150 degrees Celsius, at least 160 degrees Celsius, at least 170 degrees Celsius, at least 180 degrees Celsius, or at least 190 degrees Celsius.

The step of applying the moisture barrier material may be followed by a calendering step. Advantageously, a calender roller may be used to further smoothen the layer of moisture barrier material by the application of pressure. The calendering step may be carried out a temperature lower than a temperature at which the moisture barrier material is applied if the moisture barrier material remains in a molten state. The calendering step may be carried out at a temperature higher than a temperature at which the moisture barrier material is applied if the moisture barrier material has solidified.

The calendering step may use a calender roller kept at low temperature, therefore facilitating the cooling and setting of the molten moisture barrier material. Alternatively, the calendering process can be applied when the coating has already solidified. Preferably, the calendering step uses a calender roller maintained at a temperature lower than the melting point of the moisture barrier material.

The calender roller may have a surface made of a polished metal. The calender roller may comprise a composite surface such as nickel-carbon or nickel-teflon. Advantageously, a composite surface may reduce or prevent adhesion of the moisture barrier material to the calender roller in embodiments in which the moisture barrier material may otherwise adhere to a bare-metal roller.

The step of applying the moisture barrier material may comprise applying the moisture barrier material at a dynamic viscosity of less than 40000 millipascal seconds, preferably less than 20000 millipascal seconds, preferably less than 10000 millipascal seconds, preferably less than 5000 millipascal seconds.

During the step of applying the moisture barrier material, the method may comprise advancing the web of cellulosic material at a speed of at least 100 metres per minute, at least 110 metres per minute, at least 120 metres per minute, at least 130 metres per minute, at least 140 metres per minute, at least 150 metres per minute, at least 160 metres per minute, at least 170 metres per minute, at least 180 metres per minute, at least 190 metres per minute, at least 200 metres per minute, at least 210 metres per minute, at least 220 metres per minute, at least 230 metres per minute, or at least 240 metres per minute.

During the step of applying the moisture barrier material, the method may comprise advancing the web of cellulosic material at a speed of less than or equal to 250 meters per minute, less than or equal to 240 meters per minute, less than or equal to 230 meters per minute, less than or equal to 220 meters per minute, less than or equal to 210 meters per minute, or less than or equal to 200 meters per minute.

The method may comprise any of the additional features described with respect to the first aspect of the present invention in accordance with any of the examples or embodiments described herein.

According to a tenth aspect of the present invention, there is provided a web of multi-layer material manufactured using a method of the ninth aspect of the present invention, according to any of the examples or embodiments described herein.

According to the present disclosure, there is provided a method of manufacturing a package of consumer goods. The method may comprise forming a web of multi-layer material using a method according to the ninth aspect of the present invention. The method may comprise providing a web of multi-layer material using a method according to the ninth aspect of the present invention. The method may comprise cutting a laminar blank from the web of multi-layer material. The method may comprise folding the laminar blank to form a package of consumer goods.

According to an eleventh aspect of the present invention there is provided a method of manufacturing a package of consumer goods. The method may comprise forming a web of multi-layer material using a method of the ninth aspect of the present invention, according to any of the examples or embodiments described herein. Alternatively, the method may comprise providing a web of multi-layer material using a method of the ninth aspect of the present invention, according to any of the examples or embodiments described herein. The method also comprises cutting a laminar blank from the web of multi-layer material and folding the laminar blank to form a package of consumer goods.

The method may comprise any of the optional or preferred features described with respect to the third aspect of the present invention, in accordance with any of the examples or embodiments described herein.

According to a twelfth aspect of the present invention, there is provided a package of consumer goods manufactured using a method of the eleventh aspect of the present invention, according to any of the examples or embodiments described herein.

Below, there is provided a non-exhaustive list of non-limiting examples. Any one or more of the features of these examples may be combined with any one or more features of another example, embodiment, or aspect described herein.

Example 1: A method of manufacturing a web of multi-layer material, the method comprising:
providing a web of cellulosic material;
perforating the web of cellulosic material to form a perforated web of cellulosic material; and
applying a polymeric material to a surface of the perforated web of cellulosic material to form a web of multi-layer material, the web of multi-layer material having a perforated first layer comprising the cellulosic material and a second layer comprising the polymeric material.

Example 2: A method according to example 1, wherein the web of cellulosic material comprises a first side and a second side opposite the first side, wherein the step of perforating the web of cellulosic material comprises perforating the web of cellulosic material from the first side, and wherein the step of applying a polymeric material comprises applying the polymeric material to the second side of the web of cellulosic material.

Example 3: A method according to example 2, wherein the web of cellulosic material comprises at least one of text, graphics, logos, and indicia on the first side.

Example 4: A method according to example 3, further comprising a step of printing the at least one of text, graphics, logos, and indicia on the first side of the web of cellulosic material.

Example 5: A method according to example 4, wherein the printing step is carried out before the perforating step.

Example 6: A method according to example 4 or 5, wherein the printing step comprises at least one of lithographic printing, flexographic printing, digital printing, and gravure printing.

Example 7: A method according to any preceding example, wherein the step of perforating the web of cellulosic material comprises perforating the web of cellulosic material using a rotary die cutter.

Example 8: A method according to any preceding example, wherein the step of applying the polymeric material comprises applying the polymeric material to the cellulosic material using a slot-die coater.

Example 9: A method according to example 8 or 9, wherein the slot-die coater is a rotating bar slot-die coater.

Example 10: A method according to any preceding example, further comprising a step of calendering the second layer comprising the polymeric material to increase a smoothness of the second layer, preferably wherein the calendering step is carried out at a temperature below a melting point of the polymeric material.

Example 11: A method according to any preceding example, wherein the second layer comprising the polymeric material is a moisture barrier layer.

Example 12: A method according to any preceding example, wherein the polymeric material comprises at least one of: an homopolymer of ethylene, propylene, 1-butene, isobutene, 1-octene, 1-hexene; a copolymer of at least two monomers among ethylene, propylene, 1-butene, isobutene, 1-octene, 1-hexene, styrene; a copolymer of ethylene and vinyl acetate; a copolymer of ethylene and an ester of acrylic or methacrylic acid; a copolymer of ethylene and acrylic or methacrylic acid; a copolymer of styrene and ethylene and propylene; an hydrogenated copolymer of styrene and butadiene; and hydrogenated copolymer of styrene and isoprene; a copolymer of styrene and isobutene; and a wax

Example 13: A method according to any preceding example, wherein the polymeric material is a first polymeric material, the method further comprising a step of applying a second polymeric material to form a third layer comprising the second polymeric material.

Example 14: A method according to example 13, wherein the step of applying the second polymeric material is carried out after the step of applying the first polymeric material.

Example 15: A method according to example 13 or 14, wherein the third layer comprising the second polymeric material is a heat sealable layer.

Example 16: A method according to example 13, 14 or 15, wherein the second polymeric material comprises at least one of a copolymer of ethylene, a copolymer of methacrylic acid, a copolymer of an ester of acrylic acid, or a copolymer of an ester of methacrylic acid.

Example 17: A method according to example 13, 14 or 15, wherein the second polymeric material comprises at least one of a polymer or copolymer of ethylene, propylene, or 1-butene.

Example 18: A method according to any preceding example, further comprising slitting the web of multi-layer material to form a plurality of webs of multi-layer material.

Example 19: A method according to any preceding example, wherein the web of cellulosic material comprises a web of paper or a web of paperboard.

Example 20: A web of multi-layer material manufactured using a method according to any preceding example.

Example 21: A method of manufacturing a package of consumer goods, the method comprising:
forming a web of multi-layer material using a method according to any of examples 1 to 19;
cutting a laminar blank from the web of multi-layer material; and
folding the laminar blank to form a package of consumer goods.

Example 22: A method of manufacturing a package of consumer goods, the method comprising:
providing a web of multi-layer material manufactured using a method according to any of examples 1 to 19;
cutting a laminar blank from the web of multi-layer material; and
folding the laminar blank to form a package of consumer goods.

Example 23: A method according to example 21 or 22, wherein the second layer comprising the polymeric material forms an inner surface of the package of consumer goods.

Example 24: A method according to example 21, 22 or 23, further comprising a step of providing one or more consumer goods, wherein the step of folding the laminar blank comprises folding the laminar blank around the one or more consumer goods.

Example 25: A method according to example 24, wherein the one or more consumer goods comprises a plurality of aerosol-generating articles.

Example 26: A method according to example 24, wherein the one or more consumer goods comprises a bundle of packages of aerosol-generating articles.

Example 27: A method according to example 26, wherein each package of aerosol-generating articles is manufactured using a method according to example 25.

Example 28: A package of consumer goods manufactured using a method according to any of examples 21 to 27.

Example 29: A multi-layer material, the multi-layer material comprising:
a first layer comprising a cellulosic material;
a second layer comprising a polymeric material; and
a plurality of perforations, wherein each perforation extends only through the first layer.

Example 30: A multi-layer material according to example 29, wherein the first layer comprising the cellulosic material comprises a first side and a second side opposite the first side, wherein the perforations are formed from the first side of the first layer, and wherein the second layer comprising the polymeric material overlies the second side of the first layer.

Example 31: A multi-layer material according to example 30, wherein the first layer comprising the cellulosic material comprises at least one of text, graphics, logos, and indicia on the first side.

Example 32: A multi-layer material according to example 29, 30 or 31, wherein the second layer comprising the polymeric material is a moisture barrier layer.

Example 33: A multi-layer material according to any of examples 29 to 32, wherein the polymeric material comprises at least one of: a copolymer of styrene and acrylic esters; a copolymer of styrene and butadiene; a copolymer of ethylene and vinyl acetate; a copolymer of ethylene and acrylic or methacrylic acid; a polymer or copolymer of ethylene with propylene, 1-butene, isobutene, 1-octene, 1-hexene, or norbornene; and a wax.

Example 34: A multi-layer material according to any of examples 29 to 33, wherein the polymeric material is a first polymeric material, the multi-layer material further comprising a third layer comprising a second polymeric material.

Example 35: A multi-layer material according to example 34, wherein the third layer comprising the second polymeric material is a heat sealable layer.

Example 36: A multi-layer material according to example 34 or 35, wherein the second polymeric material comprises at least one of a copolymer of ethylene, a copolymer of methacrylic acid, a copolymer of an ester of acrylic acid, or a copolymer of an ester of methacrylic acid.

Example 37: A multi-layer material according to any of examples 29 to 36, wherein the first layer comprising the cellulosic material is a layer of paper or a layer of paperboard.

Example 38: A package of consumer goods, the package comprising:
a folded laminar blank formed from a multi-layer material according to any of examples 29 to 37; and
one or more consumer goods contained within the folded laminar blank.

Example 39: A package of consumer goods according to example 38, wherein the second layer comprising the polymeric material forms an inner surface of the folded laminar blank.

Example 40: A package of consumer goods according to example 38 or 39, wherein the one or more consumer goods is a plurality of aerosol-generating articles, and wherein the folded laminar blank forms an outer housing containing the plurality of aerosol-generating articles.

Example 41: A package of consumer goods according to example 38 or 39, wherein the one or more consumer goods is a bundle of packages of aerosol-generating articles, and wherein the folded laminar blank forms an outer wrapper wrapped around the bundle of packages of aerosol-generating articles.

Example 42: A package of consumer goods according to example 41, wherein each package of aerosol-generating articles is a package of aerosol-generating articles according to example 40.

Example 43: An apparatus configured to carry out the method according to any of examples 1 to 19 or any of examples 21 to 27.

Example 44: An apparatus for manufacturing a web of multi-layer material, the apparatus comprising:
a feeding station for feeding a web of cellulosic material;
a perforating station for perforating the web of cellulosic material to form a perforated web of cellulosic material; and
a polymer application station for applying a polymeric material to a surface of the perforated web of cellulosic material to form a web of multi-layer material, the web of multi-layer material having a perforated first layer comprising the cellulosic material and a second layer comprising the polymeric material.

Example 45: An apparatus according to example 44, wherein the perforating station is arranged to perforate a first side of the web of cellulosic material, wherein the polymer application station is arranged to apply the polymeric material to a second side of the web of cellulosic material, and wherein the second side is opposite the first side.

Example 46: An apparatus according to example 45, further comprising a turnbar positioned between the perforating station and the polymer application station.

Example 47: An apparatus according to example 44 or 45, further comprising a printing station arranged to print at least one of text, graphics, logos, and indicia on the first side of the web of cellulosic material.

Example 48: An apparatus according to example 47, wherein the printing station is positioned between the feeding station and the perforating station.

Example 49: An apparatus according to example 47 or 48, wherein the printing station comprises at least one of a lithographic printer, a flexographic printer, a digital printer, and a gravure printer.

Example 50: An apparatus according to any of examples 44 to 49, wherein the perforating station comprises a rotary die cutter.

Example 51: An apparatus according to any of examples 44 to 50, wherein the polymer application station comprises a slot-die coater.

Example 52: An apparatus according to example 51, wherein the slot-die coater is a rotating bar slot-die coater.

Example 53: An apparatus according to any of examples 44 to 52, further comprising a calender roller forming part of the polymer application station or positioned after the polymer application station, wherein the calender roller is arranged to increase a smoothness of the second layer comprising the polymeric material, optionally wherein the calender roll is arranged to be operated at room temperature, optionally wherein the calendar roll is arranged to be cooled to a temperature below room temperature.

Example 54: An apparatus according to any of examples 44 to 53, wherein the polymer application station is a first polymer application station for applying a first polymeric material, the apparatus further comprising a second polymer application station for applying a second polymeric material to form a third layer comprising the second polymeric material.

Example 55: An apparatus according to example 54, wherein the second polymer application station is positioned after the first polymer application station.

Example 56: An apparatus according to example 55, further comprising a turnbar positioned between the first polymer application station and the second polymer application station.

Example 57: An apparatus according to example 54, 55 or 56, wherein the second polymer application station comprises a pattern coater.

Example 58: An apparatus according to any of examples 54 to 57, further comprising a calender roller forming part of the second polymer application station or positioned after the second polymer application station, wherein the calender roller is arranged to increase a smoothness of the third layer comprising the second polymeric material, optionally wherein the calender roll is arranged to be operated at room temperature, optionally wherein the calendar roll is arranged to be cooled to a temperature below room temperature.

Example 59: An apparatus according to any of examples 44 to 58, further comprising a slitter arranged to slit the web of multi-layer material into a plurality of webs of multi-layer material.

Example 60: An apparatus for manufacturing a package of consumer goods, the apparatus comprising:
a web forming apparatus comprising an apparatus according to any of examples 44 to 59;
a cutting station for receiving a web of multi-layer material from the web forming apparatus and for cutting a laminar blank from the web of multi-layer material; and
a folding station for folding the laminar blank to form a package of consumer goods.

Example 61: An apparatus according to example 60, wherein the folding station is arranged to fold the laminar blank so that the second layer comprising the polymeric material forms an inner surface of the package of consumer goods.

Example 62: An apparatus according to example 60 or 61, wherein the folding station is arranged to receive one or more consumer goods and to fold the laminar blank around the one or more consumer goods.

Example 63: A method of manufacturing a web of multi-layer material, the method comprising:
providing a web of cellulosic material; and
using a rotating bar slot-die coater to apply a moisture barrier material to a surface of the web of cellulosic material to form a web of multi-layer material, the web of multi-layer material having a first layer comprising the cellulosic material and a second layer, wherein the second layer is a moisture barrier layer comprising the moisture barrier material.

Example 64: A method according to example 63, wherein the moisture barrier material comprises at least one of: a copolymer of styrene and acrylic esters; a copolymer of styrene and butadiene; a copolymer of ethylene and vinyl acetate; a copolymer of ethylene and acrylic or methacrylic acid; a polymer or copolymer of ethylene with propylene, 1-butene, isobutene, 1-octene, 1-hexene, or norbornene; and a wax.

Example 65: A method according to example 63 or 64, wherein the second layer has a thickness of less than 20 micrometres, preferably less than 18 micrometres, preferably less than 16 micrometres, preferably less than 14 micrometres, preferably less than 12 micrometres, preferably less than 10 micrometres.

Example 66: A method according to example 63, 64 or 65, wherein providing the web of cellulosic material comprises feeding the web of cellulosic material through the rotating bar slot-die coater at a speed of at least 100 metres per minute, preferably at least 125 metres per minute, preferably at least 150 metres per minute, preferably at least 175 metres per minute, preferably at least 200 metres per minute.

Example 67: A method according to any of examples 63 to 66, wherein the rotating bar slot-die coater applies the moisture barrier material at a temperature of less than 200 degrees Celsius.

Example 68: A method according to any of examples 63 to 67, wherein the second layer has a grammage of less than 20 grams per square metre, preferably less than 15 grams per square metre, preferably less than 10 grams per square metre, preferably less than 5 grams per square metre.

Example 69: A method according to any of examples 63 to 68, wherein the moisture barrier material has a composition comprising at least 5 percent by weight of one or more waxes, preferably at least 10 percent by weight of one or more waxes, preferably at least 30 percent by weight of one or more waxes, and wherein the rotating bar slot-die coater applies the moisture barrier material at a dynamic viscosity of less than 40000 millipascal seconds, preferably less than 20000 millipascal seconds, preferably less than 10000 millipascal seconds, preferably less than 5000 millipascal seconds.

Example 70: A method according to any of examples 63 to 69, wherein the web of cellulosic material comprises a web of paper or a web of paperboard.

Example 71: A method according to any of examples 63 to 70, further comprising a step of calendering the second layer comprising the polymeric material to increase a smoothness of the second layer, preferably wherein the calendering step is carried out at a temperature below a melting point of the polymeric material.

Example 72: A web of multi-layer material manufactured using a method according to any of examples 63 to 71.

Example 73: A method of manufacturing a package of consumer goods, the method comprising:
forming a web of multi-layer material using a method according to any of examples 63 to 71;
cutting a laminar blank from the web of multi-layer material; and
folding the laminar blank to form a package of consumer goods.

Example 74: A method of manufacturing a package of consumer goods, the method comprising:
providing a web of multi-layer material manufactured using a method according to any of examples 63 to 70;
cutting a laminar blank from the web of multi-layer material; and
folding the laminar blank to form a package of consumer goods.

Example 75: A method according to example 73 or 74, wherein the moisture barrier layer forms an inner surface of the package of consumer goods.

Example 76: A method according to example 73, 74 or 75, further comprising a step of providing one or more consumer goods, wherein the step of folding the laminar blank comprises folding the laminar blank around the one or more consumer goods.

Example 77: A method according to example 76, wherein the one or more consumer goods comprises a plurality of aerosol-generating articles.

Example 78: A method according to example 76, wherein the one or more consumer goods comprises a bundle of packages of aerosol-generating articles.

Example 79: A method according to example 78, wherein each package of aerosol-generating articles is manufactured using a method according to example 76.

Example 80: A package of consumer goods manufactured using a method according to any of examples 73 to 79.

The invention will now be further described, by way of example only, with reference to the accompanying drawings in which:

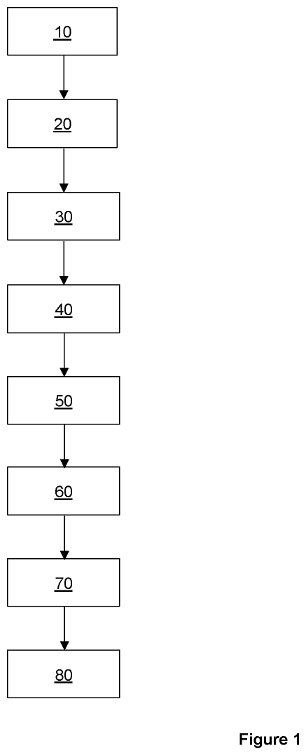

FIG. 1 shows a flow diagram illustrating the steps in a method of forming a web of multi-layer material in accordance with an embodiment of the present invention;

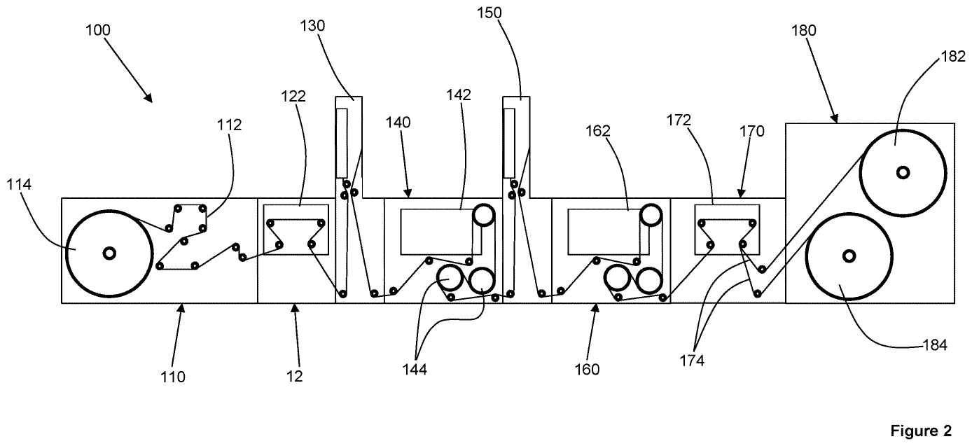

FIG. 2 illustrates a first exemplary apparatus for carrying out the method of FIG. 1;

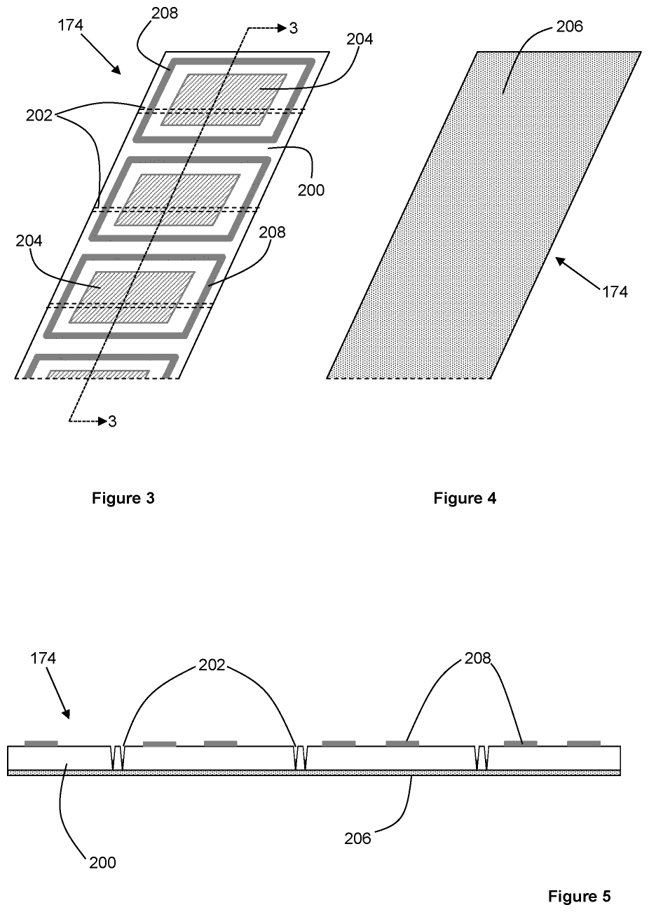

FIG. 3 shows a first side of a first embodiment of a web of multi-layer material manufactured according to the method of FIG. 1 using the apparatus of FIG. 2;

FIG. 4 shows a second side of the web of multi-layer material of FIG. 3;

FIG. 5 shows a cross-sectional view of the web of multi-layer material of FIG. 4 along line 3-3;

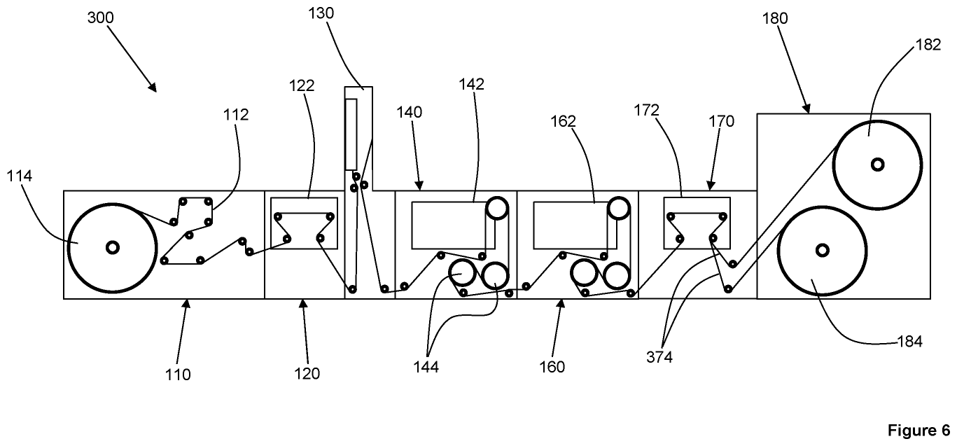

FIG. 6 shows a second exemplary apparatus for carrying out the method of FIG. 1;

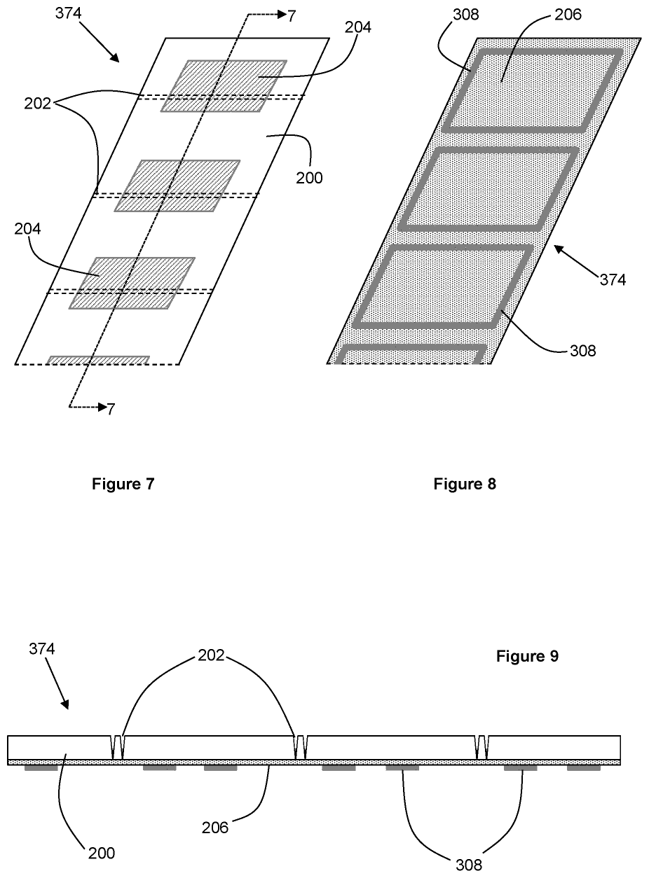

FIG. 7 shows a first side of a second embodiment of a web of multi-layer material manufactured according to a modified method of FIG. 1 using the apparatus of FIG. 6;

FIG. 8 shows a second side of the web of multi-layer material of FIG. 7;

FIG. 9 shows a cross-sectional view of the web of multi-layer material of FIG. 7 along line 7-7;

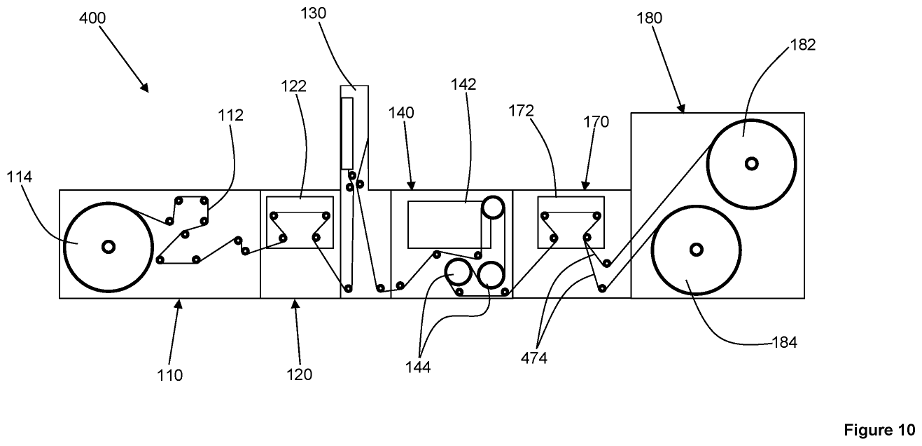

FIG. 10 shows a third exemplary apparatus for carrying out the method of FIG. 1;

FIG. 11 shows a first side of a third embodiment of a web of multi-layer material manufactured according to a modified method of FIG. 1 using the apparatus of FIG. 10;

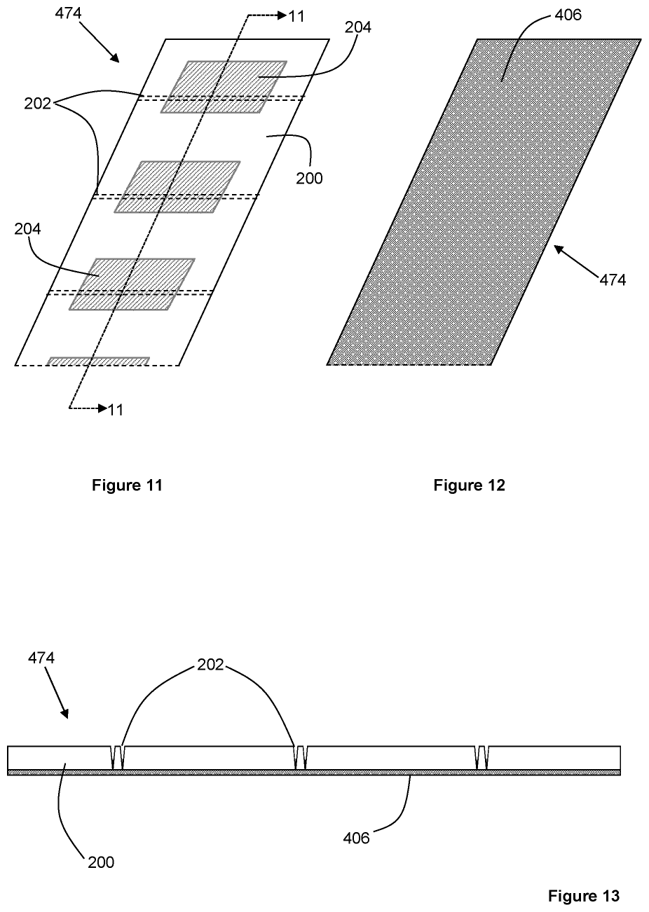

FIG. 12 shows a second side of the web of multi-layer material of FIG. 11; and

FIG. 13 shows a cross-sectional view of the web of multi-layer material of FIG. 11 along line 11-11.

FIG. 1 shows a flow diagram illustrating the step in a method of forming a web of multi-layer material in accordance with an embodiment of the present invention. The method comprises a first step 10 of unwinding a web of cellulosic material from a bobbin. In a second step 20, the web of cellulosic material is perforated on a first side of the web of cellulosic material to form a perforated web of cellulosic material. Preferably, the web of cellulosic material comprises paper or paperboard. In embodiments in which the web of multi-layer material is used to form a plurality of laminar blanks to be folded to form packages of consumer goods, the perforations may facilitate opening of the packages by a consumer. For example, the perforated web of cellulosic material may comprise lines of perforations that form tear lines or tear tapes when a laminar blank cut from the web of multi-layer material is folded to form a package of consumer goods.

In a third step 30, the perforated web of cellulosic material is reversed in preparation for a fourth step 40, which is the application of a first polymeric material to a second side of the perforated web of cellulosic material. Preferably, the first polymeric material is a moisture barrier material. Advantageously, applying a moisture barrier material after the perforation step facilitate the formation of a uniform and effective moisture barrier layer. Applying the moisture barrier material to the opposite side of the perforated web of cellulosic material to the side from which the perforations are formed may facilitate an improved visual appearance of the perforations when side of the web of multi-layer material comprising the moisture barrier layer forms an inner surface of a folded laminar blank. However, the skilled person will appreciate that third step 30 can be omitted if it is desirable to apply the first polymeric material to the first side of the perforated web of cellulosic material.

In a fifth step 50, the perforated web of cellulosic material comprising the first polymeric material is again reverse prior to a sixth step 60 in which a second polymeric material is applied to the first side of the perforated web of cellulosic material. The second polymeric material may comprise a heat sealable material. The fifth step 50 may be omitted if it is desirable to apply the second polymeric material to the same side of the perforated web of cellulosic material as the first polymeric material. Furthermore, both steps 50 and 60 may be omitted if the application of a second polymeric material is not required.

After step 40 (and after optional steps 50 and 60, if required), the perforated web of cellulosic material and the layer of first polymeric material together form a web of multi-layer material. At an optional step 70, the web of multi-layer material may be slit to form a plurality of webs of multi-layer material. Finally, at step 80, the one or more webs of multi-layer material may be re-wound onto one or more bobbins for storage or transfer to another manufacturing line.

FIG. 2 shows a schematic cross-sectional view of an apparatus 100 suitable for carrying the method of FIG. 1. The apparatus comprises a feeding station 110 for unwinding the web of cellulosic material 112 from a bobbin 114 during the unwinding step 10.

The web of cellulosic material 112 is fed to a perforating station 120 comprising a die cutter 122 arranged to perforate the web of cellulosic material 112 from a first side of the web during step 20. A first turnbar 130 then reverses the perforated web of cellulosic material 112 during step 30.

The reversed perforated web of cellulosic material 112 then proceeds to a first polymer application station 140 comprising a rotating bar slot-die coater 142 and a plurality of chilled rollers 144 for applying a first polymer to a second side of the perforated web of cellulosic material 112 in step 40. The present inventors have recognised that using a rotating bar slot-die coater facilitates the application of a thin and uniform layer of the first polymer to the perforated web of cellulosic material at relatively high web speeds, which cannot be achieved with a convention slot-die coater. This is particularly advantageous in embodiments in which the first polymer comprises a moisture barrier material, since a uniform coating that is substantially free of defects is required to provide optimum moisture barrier performance.

The improved performance of a rotating bar slot-die coater compared with a conventional slot-die coater has been observed by the present inventors during testing with the following moisture barrier formulations:

Formulation 1: a propylene homopolymer in an amount of 70 percent by weight of the moisture barrier material, a propylene-ethylene-copolymer in an amount of 14 percent by weight of the moisture barrier material, a hydrogenated aromatic hydrocarbon resin in an amount of 10 percent by weight of the moisture barrier material, and a paraffin wax in an amount of 6 percent by weight of the moisture barrier material. The paraffin wax has a melting point of 60 degrees Celsius.

Formulation 2: a propylene-ethylene-copolymer plastomer in an amount of 45 percent by weight of the moisture barrier material, a hydrogenated aromatic hydrocarbon resin in an amount of 15 percent by weight of the moisture barrier material, and a paraffin wax in an amount of 40 percent by weight of the moisture barrier material. The paraffin wax has a melting point of 60 degrees Celsius.

Formulation 3: a low molecular weight polyethylene in an amount of 45 percent by weight of the moisture barrier material, a hydrogenated aromatic hydrocarbon resin in an amount of 10 percent by weight of the moisture barrier material, a Fischer-Tropsch polyethylene wax in an amount of 10 percent by weight of the moisture barrier material, and a paraffin wax in an amount of 35 percent by weight of the moisture barrier material. The paraffin wax has a melting point of 60 degrees Celsius.

During testing, a calendered paper of 50 grams per square meter was coated with 15 grams per square meter of each of the Formulations 1, 2 and 3. The material was cooled to enable to solidification of the coating after its application by a chill roller at a temperature of 15 degrees Celsius or by using an additional Teflon coated calender roller. The first chill roller facilitates cooling of the coating from the bare paper side, while the calender roller facilitates a much quicker cooling by being in direct contact with the molten polymer layer applied from the slot die. The resulting coated paper was evaluated visually in terms of defects such a lines and coating uniformity, and in terms of water vapour or moisture transmission rate (WVTR) measured at 38 degrees Celsius and 90 percent relative humidity, using a PERMATRAN-W 3/34 H from Ametek Mocon according to the ASTM F1249 standard. The results of the testing are shown below in Table 1 and Table 2:

TABLE 1
comparison of WVTR for moisture barrier coatings applied using
a rotating bar slot-die coater and a regular slot-die coater at
web speeds of 10 metres per minute and 100 metres per minute.

| | Rotating Bar | | | Regular Slot- | | |
|---|---|---|---|---|---|---|
| | Slot-Die | | | Die (comparative) | | |
| Coating Formulation | 1 | 2 | 3 | 1 | 2 | 3 |
| WVTR (coating applied at | 12 | 5.4 | 7 | 11.3 | 6.5 | 8.8 |
| web speed of 10 metres | | | | | | |
| per minute) | | | | | | |
| WVTR (coating applied at | 10.3 | 6.1 | 6.6 | 35.2* | 53.2* | 47.8* |
| web speed of 100 metres | | | | | | |
| per minute) | | | | | | |

TABLE 2
comparison of WVTR for moisture barrier coatings applied using a
rotating bar slot-die coater with and without a calendering step
at web speeds of 10 metres per minute and 100 metres per minute.

| | Rotating Bar | | | Rotating Bar Slot-Die | | |
|---|---|---|---|---|---|---|
| | Slot-Die | | | and Calendering | | |
| Coating Formulation | 1 | 2 | 3 | 1 | 2 | 3 |
| WVTR (coating applied at | 12 | 5.4 | 7 | 9.5 | 4.3 | 3.5 |
| web speed of 10 metres | | | | | | |
| per minute) | | | | | | |
| WVTR (coating applied at | 10.3 | 6.1 | 6.6 | 8.9 | 4.1 | 3.2 |
| web speed of 100 metres | | | | | | |
| per minute) | | | | | | |

As shown in Table 1, the performance of the rotating bar slot-die coater and the regular slot-die coater in the deposition of a moisture barrier coating is broadly comparable at a low web speed of 10 metres per minute. However, at a production speed of 100 metres per minute, the regular slot-die coater exhibited a clear deterioration in the WVTR of the deposited coating. Furthermore, the coatings applied using the regular slot-die coater at a web speed of 100 metres per minute showed visual irregularities in the coating such as lines or other defects, denoted by the asterisk in Table 1. On the other hand, the rotating bar slot-die coater showed no significant change in the WVTR of the applied coatings when the web speed was increased from 10 metres per minute to 100 metres per minute. At a web speed of 100 metres per minute, the rotating bar slot-die coater remained capable of depositing coatings that were substantially free of defects and exhibited satisfactory moisture barrier performance.

The effect of a cooled calendering step is also noteworthy (see Table 2). The improvement in moisture barrier performance is deemed to be a result of the additional smoothing effect of the calender roller. Furthermore, the rapid cooling of the molten polymer coating may decrease the growth of crystallites comprised of polymers or waxes, further increasing the barrier performance.

Returning to the apparatus 100 of FIG. 2, the apparatus 100 further comprises a second turnbar 150 arranged to reverse the coated perforated web of cellulosic material 112 in step 50 of the method of FIG. 1. A second polymer application station 160 comprising a pattern coater 162 is then used to apply a second polymeric material, such as a heat sealable material, to the first side of the perforated web of cellulosic material 112 in step 60. The coated and perforated web of cellulosic material 112, which forms a web of multi-layer material, is then slit at a slitting station 170 comprising a slitter 172 during step 70. Finally, the multiple webs of multi-layer material 174 are fed to a winding station 180 and wound onto separate bobbins 182, 184 in step 80.

FIGS. 3 and 4 show perspective views of first and second sides of a portion of a web of multi-layer material 174 manufactured using the method of FIG. 1 on the apparatus of FIG. 2. FIG. 5 shows a cross-sectional view of the web of multi-layer material 174 taken along line 3-3. The web of multi-layer material 174 comprises a first layer 200 comprising the perforated web of cellulosic material 112. The perforated web of cellulosic material 112 comprises a plurality of perforations lines 202 each extending across a width of the web of cellulosic material 112. A plurality of indicia 204 have been printed previously on a first side of the web of cellulosic material 112 in a separate printing process.

The second polymeric material comprising a moisture barrier material has been applied as a continuous coating on a second side of the web of cellulosic material 112. The continuous coating of the moisture barrier material forms a second layer 206 of the web of multi-layer material 174.

The third polymeric material comprising a heat sealable material has been applied in a repeating pattern on the first side of the web of cellulosic material 112. The repeating pattern of the heat sealable material forms a third layer 208 of the web of multi-layer material 174.

The indicia 204, the perforation lines 202 and the third layer 208 of heat sealable material are arranged in a repeated pattern in the machine direction of the web of multi-layer material 174 to allow multiple laminar blanks to be cut from the web of multi-layer material 174 in a separate, downstream process.

FIG. 6 shows a schematic cross-sectional view of a second apparatus 300 suitable for carrying out a modified method for manufacturing a web of multi-layer material. As discussed above with reference to FIG. 1, the step 50 comprising a second reversal of the perforated web of cellulosic material 112 is an optional step. Therefore, the apparatus 300 of FIG. 6 is identical to the apparatus 100 of FIG. 2 (and like reference are used to denote like parts), with the exception of the second turnbar 150 that has been removed. Otherwise, the operation of the apparatus 300 of FIG. 6 is identical to the operation of the apparatus 100 of FIG. 2 and results in the manufacture of modified webs of multi-layer material 374.

FIGS. 7 and 8 show perspective views of first and second sides of a portion of a web of multi-layer material 374 manufactured using the modified method of FIG. 1 (with step 50 removed) on the apparatus 300 of FIG. 6. FIG. 5 shows a cross-sectional view of the web of multi-layer material 374 taken along line 7-7.

The web of multi-layer material 374 of FIGS. 7 to 9 is similar to the web of multi-layer material 174 of FIGS. 3 to 5, and like reference numerals are used to designate like parts. The difference between the two webs is the position of the third layer 308 of the second polymeric material, which is positioned on the second side of the web of cellulosic material 112 and overlying the second layer 206 of the first polymeric material. The positioning of the second polymeric material on either the first side or the second side of the web of cellulosic material 112 may be dependent on the intended application of the web of multi-layer material.

FIG. 10 shows a schematic cross-sectional view of a third apparatus 400 suitable for carrying out a further modified method for manufacturing a web of multi-layer material. As discussed above with reference to FIG. 1, the step 50 comprising a second reversal of the perforated web of cellulosic material 112 and step 60 comprising the application of a second polymeric material are both optional steps. Therefore, the apparatus 400 of FIG. 10 is identical to the apparatus 300 of FIG. 6 (and like reference are used to denote like parts), with the exception of the second polymer application station 160 that has been removed. Otherwise, the operation of the apparatus 400 of FIG. 10 is identical to the operation of the apparatus 300 of FIG. 6 and results in the manufacture of modified webs of multi-layer material 474.

FIGS. 11 and 12 show perspective views of first and second sides of a portion of a web of multi-layer material 474 manufactured using the modified method of FIG. 1 (with steps 50 and 60 removed) on the apparatus 400 of FIG. 11. FIG. 13 shows a cross-sectional view of the web of multi-layer material 474 taken along line 11-11.

The web of multi-layer material 474 of FIGS. 11 to 13 is similar to the web of multi-layer material 374 of FIGS. 7 to 9, and like reference numerals are used to designate like parts. The difference between the two webs concerns the nature of the second layer 406. In particular, the first polymer application station 140 of the apparatus 400 has been used to apply a polymeric mixture comprising both a moisture barrier material and a heat sealable material. Therefore, the second layer 406 forms both a moisture barrier layer and a heat sealable layer. As such, the modified method of FIG. 1 carried out using the apparatus 400 of FIG. 10 may eliminate the need to separately apply a moisture barrier material and a heat sealable material to the perforated web of cellulosic material 112.

1. A method of manufacturing a web of multi-layer material, the method comprising:
providing a web of cellulosic material;
perforating the web of cellulosic material to form a perforated web of cellulosic material; and
applying a polymeric material to a surface of the perforated web of cellulosic material to form a web of multi-layer material, the web of multi-layer material having a perforated first layer comprising the cellulosic material and a second layer comprising the polymeric material, and
wherein the layer of polymeric material covers, infills, or covers and infills the perforations on the surface of the web of cellulosic material to which the polymeric material is applied.

2. A method according to claim 1, wherein the web of cellulosic material comprises a first side and a second side opposite the first side, wherein the step of perforating the web of cellulosic material comprises perforating the web of cellulosic material from the first side, and wherein the step of applying a polymeric material comprises applying the polymeric material to the second side of the web of cellulosic material.

3. A method according to claim 1, wherein the web of cellulosic material comprises at least one of text, graphics, logos, and indicia on a surface of the web of cellulosic material.

4. A method according to claim 3, further comprising a step of printing the at least one of text, graphics, logos, and indicia on the web of cellulosic material, wherein the printing step is carried out before the perforating step.

5. A method according to claim 1, wherein the step of perforating the web of cellulosic material comprises perforating the web of cellulosic material using a rotary die cutter.

6. A method according to claim 1, wherein the step of applying the polymeric material comprises applying the polymeric material to the cellulosic material using a slot-die coater.

7. A method according to claim 6, wherein the slot-die coater is a rotating bar slot-die coater.

8. A method according to claim 7, wherein the rotating bar slot-die coater comprises at least one chilled roller.

9. A method according to claim 8, wherein the at least one chilled roller comprises a water-cooling circuit arranged inside the chilled roller.

10. A method according to claim 9, wherein the water-cooling circuit has a spiral shape.

11. A method according to claim 1, wherein the second layer comprising the polymeric material is a moisture barrier layer.

12. A method according to claim 1, wherein the polymeric material comprises at least one of: an homopolymer of ethylene, propylene, 1-butene, isobutene, 1-octene, 1-hexene; a copolymer of at least two monomers among ethylene, propylene, 1-butene, isobutene, 1-octene, 1-hexene, styrene; a copolymer of ethylene and vinyl acetate; a copolymer of ethylene and an ester of acrylic or methacrylic acid; a copolymer of ethylene and acrylic or methacrylic acid; a copolymer of styrene and ethylene and propylene; an hydrogenated copolymer of styrene and butadiene; and hydrogenated copolymer of styrene and isoprene; a copolymer of styrene and isobutene; and a wax.

13. A method according to claim 1, wherein the polymeric material is a first polymeric material, the method further comprising a step of applying a second polymeric material to form a third layer comprising the second polymeric material.

14. A method according to claim 13, wherein the step of applying the second polymeric material is carried out after the step of applying the first polymeric material.

15. A method according to claim 13, wherein the third layer comprising the second polymeric material is a heat sealable layer.

16. A method according to claim 13, wherein the second polymeric material comprises at least an homopolymer of ethylene, propylene, 1-butene, isobutene, 1-octene, 1-hexene; a copolymer of at least two monomers among ethylene, propylene, 1-butene, isobutene, 1-octene, 1-hexene, styrene; a copolymer of ethylene and vinyl acetate; a copolymer of ethylene and an ester of acrylic or methacrylic acid; a copolymer of ethylene and acrylic or methacrylic acid; a copolymer of styrene and ethylene and propylene; an hydrogenated copolymer of styrene and butadiene; and hydrogenated copolymer of styrene and isoprene; a copolymer of styrene and isobutene.

17. A method according to claim 1, further comprising at least one step of calendering the web of multi-layer material, wherein the at least one calendering step is carried out using at least one roller, optionally wherein the at least one roller is operated at room temperature, optionally wherein the at least one roller is cooled to a temperature below room temperature.

18. A method according to claim 17, wherein the polymeric material is a first polymeric material, the method further comprising a step of applying a second polymeric material to form a third layer comprising the second polymeric material, wherein the at least one step of calendering the web of multi-layer material comprises a first calendering step after the step of applying the first polymeric material and a second calendering step after the step of applying the second polymeric material.

19. A method according to claim 17 wherein the polymeric material is a first polymeric material, the method further comprising a step of applying a second polymeric material to form a third layer comprising the second polymeric material, wherein the at least one step of calendering the web of multi-layer material comprises a single calendering step after the steps of applying the first polymeric material and applying the second polymeric material.

20. A web of multi-layer material manufactured using a method according to claim 1.

21. A method of manufacturing a package of consumer goods, the method comprising:
forming a web of multi-layer material using a method according to claim 1;
cutting a laminar blank from the web of multi-layer material; and
folding the laminar blank to form a package of consumer goods.

22. A method according to claim 21, wherein the second layer comprising the polymeric material forms an inner surface of the package of consumer goods.

23. A method according to claim 21, further comprising a step of providing one or more consumer goods, wherein the step of folding the laminar blank comprises folding the laminar blank around the one or more consumer goods.

24. A multi-layer material, the multi-layer material comprising:
a first layer comprising a cellulosic material;
a second layer comprising a polymeric material; and
a plurality of perforations, wherein each perforation extends only through the first layer,
wherein the layer of polymeric material covers, infills, or covers and infills the perforations on the surface of the layer of cellulosic material to which the polymeric material is applied.

25. A package of consumer goods, the package comprising:
a folded laminar blank formed from a multi-layer material according to claim 24; and
one or more consumer goods contained within the folded laminar blank.

26. An apparatus for manufacturing a web of multi-layer material, the apparatus comprising:
a feeding station for feeding a web of cellulosic material;
a perforating station for perforating the web of cellulosic material to form a perforated web of cellulosic material; and
a polymer application station for applying a polymeric material to a surface of the perforated web of cellulosic material to form a web of multi-layer material, the web of multi-layer material having a perforated first layer comprising the cellulosic material and a second layer comprising the polymeric material, wherein the layer of polymeric material covers, infills, or covers and infills the perforations on the surface of the web of cellulosic material to which the polymeric material is applied.

27. A method of manufacturing a web of multi-layer material, the method comprising:
providing a web of cellulosic material; and
using a rotating bar slot-die coater to apply a moisture barrier material to a surface of the web of cellulosic material to form a web of multi-layer material, the web of multi-layer material having a first layer comprising the cellulosic material and a second layer, wherein the second layer is a moisture barrier layer comprising the moisture barrier material.
